(19) United States
(12) Patent Application Publication
(10) Pub. No.: US 2008/0206532 A1
(43) Pub. Date: Aug. 28, 2008

(54) Vapor Dispersible Plastic Film with Paint Adherence and Cling

(76) Inventor: Graham M. Chapman, Niagara- on- the- Lake (CA)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 11/914,900

(22) PCT Filed: May 18, 2006
(86) PCT No.: PCT/US06/19248

§ 371 Date: Nov. 19, 2007

Related U.S. Application Data
(60) Provisional application No. 60/682,874, filed on May 18, 2005.

(51) Int. Cl. B32B 7/02

(52) U.S. Cl. 428/216

(57) ABSTRACT

A co-extruded plastic film comprises an outer layer (12) formed of a polymer or co-polymer having a high surface energy, such as corona treated high density polyethylene; a core layer (14) preferably formed of a polyolefin, which can included a foamed polymer preferably formed by an exothermic blowing agent; and an inner layer (16) that includes a filler of sufficiently large particle size and in an sufficiently large amount that water vapor can escape laterally from under the film. The inner layer can also include a desiccant and be embossed. This film allows vapors to disperse and can also be moisture absorbent and vapor permeable. The film also has the benefit that one surface has high paint adherence and the opposite surface clings to a substrate, typically a painted metal or simple metal surface.

### BACKGROUND OF THE INVENTION

The art of modifying and controlling the vapor permeability of thin polymer films is well established in the plastics industry. This control is mostly concerned with modifying the transmission through the film of small molecules, such as those of water, carbon dioxide and nitrogen and is generally confined to a temperature range from 4° C. to around body temperature of 37° C. However, for certain applications, such as those involving the curing of paints, it is important to control the vapor transmission of plastic film at temperatures around 60° C. The vapor molecules involved, apart from moisture, tend to be low molecular weight organic compounds used as solvents.

The use of a multi-layer plastic film for paint masking and protection of a vehicle has already been described in Applicant's co-pending patent application Ser. No. 10/784,857, which is incorporated herein by reference. This film has the benefits of paint adherence (to catch the overspray from the spraying process) and cling to help the placement of the film on the vehicle. However, when the film is placed on a damp or wet vehicle after the curing process at around 60° C., there can be patches referred to as “ghosting” or “bloom” on the painted surface of the vehicle. These blemishes are unacceptable to the consumer and can result in considerable cost to remedy.

There is therefore a need to provide a film that has all the benefits of the aforementioned protective film together with the benefit of preventing “bloom” when used on a damp or wet vehicle.

A new method to measure the performance of different films with respect to “bloom” was developed. This consisted of painting metal sheet with a typical automotive paint—two layers of etching undercoat, three layers of colored basecoat and two layers of clearcoat. This would then be sprayed with moisture from an atomizing bottle and strips of the plastic films to be tested would then be fixed to the surface. The metal sheet is placed in an oven at 60° C. for 30 minutes. After cooling the film is stripped off and the amount of “bloom” is estimated. A scale from 0 to 100% is used to describe the amount of bloom under each of the strips. 100% refers to a surface where the paint is still visible as 100% and there is no ghosting. 0% refers to a surface on which it is totally “bloomed”. Simple polyethylene film gives a result between 0 and 30%. A good film for damp vehicles gives a result between 75 and 100%.

### BRIEF SUMMARY OF THE INVENTION

In one aspect of the invention a filler is added to the layer in contact with the vehicle to provide a rough surface to the film, thereby preventing closure of the film surface over the vehicle and entrapping the volatiles under the film. In addition, a desiccant can be included in this layer to help absorb the moisture.

The fillers in the film help raise the vapor transmission rate of the film, particularly when the film is blown with a high blow-up ratio. This helps prevent the entrapment of volatiles under the film during curing of the paint. Fillers having a medium particle size of at least about 5 microns and preferably greater than 8 microns are preferred. The use of high cling material such as high molecular weight high density polyethylene, or linear low density polyethylene for the inner layer provides an inner layer that clings well to the underlying surface while at the same time providing good vapor transmission properties. Embossing the inner layer also can be employed to provide a rough surface.

Another way in which the vapor transmission rate can be increased is to foam the film, particularly the core layer, which tends to be the thickest layer. Foaming of thermoplastic polymers in film blowing has been described previously, e.g. by Boyd et al U.S. Pat. No. 4,657,811, but in the present invention the foaming is achieved by incorporating a chemical blowing agent, preferably an endothermic blowing agent, with the extrusion melt.

To provide improved paint adherence to the outer surface of the film, the outer surface can be formed of high density polyethylene, preferably medium molecular weight high density polyethylene (MMW HDPE). High molecular weight and low molecular weight HDPE also are satisfactory. The film desirably is corona treated to a level greater than 35 dynes/cm and preferably to 45 or 50 dynes/cm or more. In this way the paint adherence of the film is achieved. If desired, a relatively polar polymer, such as ethylene vinyl acetate can be incorporated into the outer layer.

These and other features, objects, and benefits of the invention will be recognized by one having ordinary skill in the art and by those who practice the invention, from the specification, the claims, and the drawing figures.

### BRIEF DESCRIPTION OF THE SEVERAL VIEWS OF THE DRAWING

FIG. 1 is a cross sectional view of a three layer plastic film in accordance with the present invention.

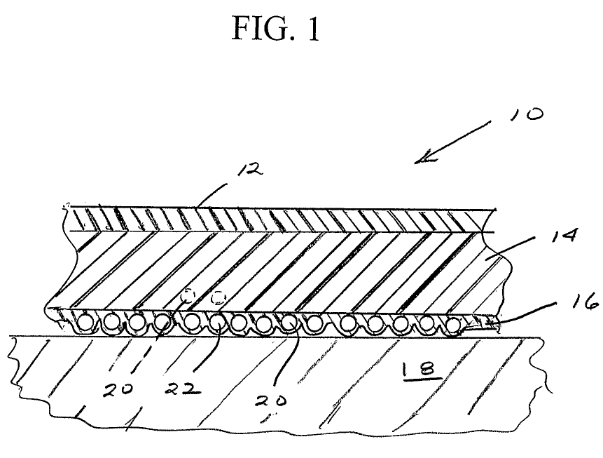

### DETAILED DESCRIPTION OF THE INVENTION

The films 10 described are made by thermoplastic co-extrusion of polyolefins using the established blown film process or film casting. The weight thickness of the film is between 0.3 mil and 0.5 ml, although, either because of the foaming process, the use of particulate fillers or embossing, the caliper thickness of the film can be as high as 4.5 mil. A three-layer film is described herein, but a film having a greater number or a smaller number of layers can be employed.

The main thermoplastic polymers used in the film layers are selected for physical properties of the finished film and cost. Typically polyolefins are used from the groups comprising low density polyethylene, medium density polyethylene, high density polyethylene, linear low density polyethylene, metallocene low density polyethylene, homopolymer polypropylene, copolymer polypropylene and thermoplastic olefins.

The outer layer 12 may incorporate a relatively polar polymer with surface energy significantly higher than a pure polyolefin, such as ethylene vinyl acetate (with a vinyl acetate content from 3 to 28%), ethylene vinyl alcohol (with an ethylene content between 27 and 48%), poly-(ethylene acrylic acid), poly-(ethylene methyl acrylic acid), neutralized poly-(ethylene acrylic acid), poly-(ethylene methylacrylate), poly-(ethylene ethyl acrylate). However, a corona treated high density polyethylene provides sufficient surface energy for paint cling. Medium molecular weight HDPE is preferred, but high molecular weight and low molecular weight HDPE are satisfactory.

The outer layer is also treated to produce a relatively higher surface energy, typically by corona treatment (ionization of the air caused by the stress of high voltage impress across an insulator), but other methods can be used, e.g. flame treatment. The level of treatment is to a level greater than 35 dynes/cm., and can be as high as 50 dynes/cm. A level of greater than 45 dynes/cm is especially desirable.

The core layer 14 is usually the main structural layer, typically being as high as 50% of the structure's weight. In addition to the polyolefin selected, some recycled resin, as high as 50%, can be incorporated in this layer.

To increase the vapor permeability of the overall structure the core, which can be the most significant vapor barrier, can be foamed. Foaming during extrusion can be achieved by several means, either chemical or physical. In chemical foaming the foaming agent decomposes or reacts at a particular temperature in the extrusion process. This can either be exothermic, such as the release of nitrogen from the decomposition of azodicarbonamide, or endothermic, such as the release of carbon dioxide from the reaction of sodium bicarbonate and an acid. For physical foaming the foaming agent is directly injected into the polymer melt. The compounds injected can be either liquids, such as pentane or butane, or gases, such as carbon dioxide or nitrogen. The disadvantage of the injection method is that it requires machinery modification, so the method used in the present invention is the incorporation of a chemical blowing agent, particularly an endothermic blend.

Endothermic blowing agents are available from various suppliers, such as Ampacet's 703061-H, which contains 50% foaming agent and generates gas in the temperature range of 192-215° C. This range is typically encountered during polyolefin extrusion. The amount of the concentrate added can be between 0.1 and 2.0%, but even at the lower level an increase in vapor permeability is observed.

The inner layer 16 of the plastic film structure is the one that is in contact with the vehicle 18 or other substrate and therefore has most effect on the generation of “bloom” or “ghosting” when a damp vehicle has the film applied and is sent for curing. With a simple polyethylene inner layer, after using the film to cover a damp vehicle and curing of new paintwork at 60° C., there are light patches visible where the moisture had been. This is the problematic “ghosting” or “blooming”. In the present invention this simple inner layer is modified by one or a combination of ingredients.

To provide cling to the vehicle surface, an inner layer of HMW HDPE is preferred. Linear low density polyethylene (LLDPE) also can be used. This material is then modified or treated in order to provide vapor transmissivity without losing cling properties.

To improve vapor transmissivity, a filler 20 is incorporated, such as calcium carbonate, talc, diatomaceous earth and other silicates and silicas. The filler needs to be of relatively large particle size in order to impart sufficient surface “roughness” to the film so as to permit lateral escape of vapor. An average particle size of 4 microns will work. A particle size of at least 5 microns and desirably at least 8 microns is preferred. An especially preferred particle size has an average diameter around 10 microns, with a cut off of 17 to 80 microns. The amount added is a compromise between improving the “roughness” and the negative effect on the physicals of the film. The range of addition is 5 to 50% of the concentrate (which contain 50 to 75% filler additive). This provides a modified surface that helps diffusion of the vapors from the painted vehicle surface; apart from the moisture vapor there are volatile solvents from the paint, typically low molecular weight organics.

In addition to a filler, a dessicant 22 can be added to absorb some of the moisture vapor. This is typically in the form of a calcium oxide concentrate, such as Ampacet's 101499 containing a nominal 50% calcium oxide. At the curing temperature there is a rapid irreversible reaction whereby the calcium oxide reacts with the moisture vapor to form calcium hydroxide. The dessicant also can serve as a filler and will impart a surface roughness that enhances lateral escape of vapor.

The inner layer also can be embossed in order to increase the roughness and vapor transmissivity of the inner layer.

Another feature of the invention is that a very low density polyethylene or an ultra linear low density polyethylene can be added to any or all of the layers, up to a level of 50%, in order to increase the porosity of the layer. The increased porosity and vapor permeability of the layer and the film facilitates the transport of molecules through the film.

Also, to improve the porosity of the film, during the film blowing process, the blow up ratio is more than 3.5:1 and even more than 4.5:1. When this is done with a film containing the filler particulates the vapor transmission rate is increased.

### EXAMPLES

Film trials were carried out on a 3-layer Alpine extrusion line with the following extruders:

| | | |
|---|---|---|
| 75 mm (3 in.) | 24:1 | Grooved feed |
| 65 mm (2.6 in.) | 21:1 | Grooved feed |
| 50 mm (2 in.) | 21:1 | Grooved feed |

Die diameter: 200 mm (7.9 in.)

Structures run by weight 10:50:40, inside:middle:outside

Three layer films were blown with the following constructions:

| | Outer | Middle | Inner |
|---|---|---|---|
| A | HMW HDPE | HMW HDPE | HMW HDPE |
| B | 20% EVA | HMW HDPE | HMW HDPE |
| | 80% MMW HDPE | | |
| C | 20% EVA | 1% Blowing Agent | HMW HDPE |
| | 80% MMW HDPE | 99% HMW HDPE | |
| D | 20% EVA | 1% Blowing Agent | 20% Calcium Carbonate |
| | 80% MMW HDPE | 99% HMW HDPE | 40% ULLDPE |
| | | | 40% HMW HDPE |

The films were run with a blow-up ratio of 4.5:1 and the physical test results were:

| | Gauge | WVTR | OTR |
|---|---|---|---|
| | Mil | g · m⁻² · day⁻¹ | g · m⁻² · day⁻¹ |
| A | 0.8 | 23.3 | 12153 |
| B | 0.5 | 23.3 | 9770 |
| C | 0.4 | 30.4 | 10439 |
| D | 0.5 | 30.2 | 10447 |

The bloom, measured according to the test method described above, of these films was:

| | Bloom rating |
|---|---|
| A | 35 |
| B | 40 |
| C | 73 |
| D | 85 |

These results demonstrated that increasing the vapor transmission rates helped prevent the development of “ghosting” or “bloom” on the painted surface that had moisture before application of the film and curing.

Further tests including desiccant or coarse particle sized fillers and/or desiccant in one or two layers resulted in the following values:

| Inner layer | Core layer | Outside layer | Bloom rating |
|---|---|---|---|
| 40% coarse | 20% coarse | 100% HDPE | 100 |
| particle sized filler | particle size filler | | |
| 60% MMW HDPE | 80% HDPE | | |
| 40% desiccant (CaO) | 100% HDPE | 100% HDPE | 100 |
| 60% MMW HDPE | | | |

It will be understood by one having ordinary skill in the art and by those who practice the invention, that various modifications and improvements may be made without departing from the spirit of the disclosed concept. Various relational terms, including left, right, front, back, top, and bottom, for example, are used in the detailed description of the invention and in the claims only to convey relative positioning of various elements of the claimed invention. The scope of protection afforded is to be determined by the claims and by the breadth of interpretation allowed by law.

We claim:

1. A vapor dispersible plastic film comprising:
an outer layer with a thickness between 0.05 mil and 0.5 mil comprising at least one of polyethylene and polyproylene;
a core layer with a thickness between 0.2 mil and 1.5 mil by weight measurement comprising at least one of polyethylene and polyproylene; and
an inner layer with a thickness between 0.05 mil and 0.5 mil comprising at least one of polyethylene and polypropylene, the inner layer further including an effective quantity of a filler having a particle size sufficient to increase the roughness and vapor transmissivity of the film.

2. A plastic film according to claim 1 having an overall thickness of 0.35 mil to 2.5 mil by weight measurement.

3. A plastic film according to claim 1 in which the outer layer comprises up to 50% by weight of a relatively polar polymer with a relatively high surface energy that is substantially higher than pure polyethylene.

4. A plastic film according to claim 3 wherein said polar polymer comprises at least one of ethylene vinyl acetate and ethylene vinyl alcohol.

5. A plastic film according to claim 3 wherein said polar polymer comprises at least one of ethylene vinyl acetate (with a vinyl acetate content from 3 to 28%), ethylene vinyl alcohol (with an ethylene content between 27 and 48%), poly-(ethylene acrylic acid), poly-(ethylene methyl acrylic acid), neutralized poly-(ethylene acrylic acid), poly-(ethylene methylacrylate), and poly-(ethylene ethyl acrylate).

6. A plastic film according to claim 1 wherein the outer layer is corona treated to a level greater than 35 dynes/cm.

7. A plastic film according to claim 6 wherein the outer layer is corona treated to a level greater than 45 dynes/cm.

8. A plastic film according to claim 1 wherein the core layer comprises between 5 and 50% by weight a filler.

9. A plastic film according to claim 8 wherein the filler comprises one or more components selected from the group consisting of calcium carbonate, talc, diatomaceous earth, mica and precipitated silicas.

10. A plastic film according to claim 1 wherein the inner layer comprises between 3 and 50% of a filler that causes the inner layer to have an uneven surface.

11. A plastic film according to claim 10 wherein the filler comprises one or more members selected from the group consisting of calcium carbonate, talc, diatomaceous earth, mica or precipitated silicas.

12. A plastic film according to claim 1 in which the core layer comprises between 3 and 50% of a filler that causes the inner layer to have an uneven surface.

13. A plastic film according to claim 12 wherein the fillers included in the core have a median particle size of at least 5 microns.

14. A plastic film according to claim 12 wherein the fillers included in the core have a median particle size greater than 8 microns.

15. A plastic film according to claim 1 in which the inner layer is embossed to provide an uneven surface.

16. A plastic film according to claim 1 wherein the core layer is foamed during extrusion of the film by means of a chemical blowing agent, such that the film has enhanced roughness and higher vapor transmission in comparison with a non-foamed material.

17. A plastic film according to claim 16 in which the core layer is foamed with an endothermic blowing agent.

18. A plastic film according to claim 7 wherein the outer layer comprises one or more of medium molecular weight, high molecular weight, and low molecular weight high density polyethylene.

19. A plastic film according to claim 18 wherein the outer layer comprises medium molecular weight high density polyethylene.
